(19) United States
(12) Patent Application Publication
(10) Pub. No.: US 2023/0203878 A1
(43) Pub. Date: Jun. 29, 2023

(54) Barrier

(71) Applicant: SHENZHEN LIYI99.COM, LTD., Shenzhen (CN)

(72) Inventor: Xuzhong Wang, Shenzhen (CN)

(73) Assignee: SHENZHEN LIYI99.COM, LTD., Shenzhen (CN)

(21) Appl. No.: 18/089,270

(22) Filed: Dec. 27, 2022

(30) Foreign Application Priority Data
Dec. 28, 2021 (CN) 202123362809.3
Apr. 2, 2022 (CN) 202220770811.X
May 5, 2022 (CN) 202221058091.0
May 5, 2022 (CN) 202221058092.5

(51) Int. Cl. E06B 9/06

(52) U.S. Cl. CPC E06B 9/0653; E06B 2009/002

(57) ABSTRACT

A barrier includes a frame and a gate engaged within the frame, the barrier has a first state and a second state, a length of the frame in the second state being smaller than that in the first state, and a length of the gate in the second state being smaller than that in the first state.

### FIELD OF THE INVENTION

The present invention generally relates to assembly gates or barriers and more specifically relates to gates or barriers that are shipped or stored in one form and used in another form.

### BACKGROUND OF THE INVENTION

Generally, in order to prevent children or pets from leaving the room casually, or entering or leaving a specific door place, a detachable assembled gate or barrier may be installed on the doorframe or aisle. Such a barrier may include two states, a first state in which the barrier is assembled and in use, and a second state in which the barrier is disassembled for storage or transportation.

These barriers typically include an end frame and a gate frame engaged within the end frame. The length of the end frame and gate frame is usually standard or fixed. In order to adapt to doorframes or aisles with different widths, extensions may be used, for example as disclosed in U.S. Pat. No. 6,655,087 to Anderson, the entirety of which is hereby incorporated by reference herein. In the barrier of U.S. Pat. No. 6,655,087, the extension part is arranged on an outside of the end frame, but the opening defined by the end frame and the gate frame remains unchanged, which makes the doorframe or aisle narrower after the barrier is installed.

### SUMMARY OF THE INVENTION

In one aspect, a barrier as disclosed herein in a first engaging state is advantageously as structurally sound as a nonassembly barrier. Additionally, the barrier is capable of taking a form that occupies a minimum amount of space after conversion from the first state to a first disassembled state.

In one example, a barrier comprises: a frame and a gate engaged within the frame. The barrier has a first engaging state, in which the barrier is assembled and in use and a second disassembled state, in which the barrier is at least partially disassembled. A length of the frame in the second state is smaller than that in the first state, and a length of the gate in the second state is smaller than that in the first state. Generally, the first state is a state in which the barrier is assembled and capable of blocking access from one area to another, for example in hallway or a doorframe, and the second state is a state in which the barrier cannot be used normally.

The foregoing example of a barrier may include any one or more of the following optional features, structures, and/or forms.

In another optional form, the frame includes a first end frame and a second end frame, and the gate includes a first gate frame and a second gate frame.

In another optional form, in first engaging state, the first end frame, the second end frame, the first gate frame and the second gate frame remain engaged and the barrier is one-piece.

In another optional form, in the first disassembled state, the first end frame and the second end frame remain engaged, the first gate frame and the second gate frame remain engaged, and the barrier is disassembled into two sections.

In another optional form, in the first disassembled state, only the second end frame and the second gate frame remain engaged and the barrier is disassembled into three sections.

In another optional form, in the first disassembled state, the first end frame, the second end frame, the first gate frame and the second gate frame are disengaged with each other, and the barrier is disassembled into four sections.

In another optional form, in the first disassembled state, only the first gate frame and the second gate frame remain engaged, and the barrier is disassembled into three-sections.

In another aspect, a barrier as disclosed herein is as structurally sound as a nonassembly barrier in a first engaging state and also in a second engaging state. Additionally, the barrier is capable of adapting to wider doorframe or aisle and having wider opening after conversion from the first engaging state to the second engaging state.

In one example, a barrier comprises: a frame and a gate engaged within the frame. The barrier has a first engaging state and a second engaging state. The first engaging state and the second engaging state are both states in which the barrier is assembled and capable of blocking access from one area to another, for example in hallway or a doorframe. A length of the frame in the second engaging state is greater than that in the first engaging state, and a length of the gate in the second engaging state is greater than that in the first engaging state.

The foregoing example of a barrier may include any one or more of the following optional features, structures, and/or forms.

In one optional form, the gate includes a first gate frame and a second gate frame, and, relative to the first state, in the second state, the gate further includes an extension engaged between the first gate frame and the second gate frame.

In another optional form, the gate includes a first gate frame and a second gate frame, and the gate further includes a first extension engaged between the first gate frame and the second gate frame in the first engaging state. The gate further includes a second extension engaged between the first gate frame and the second gate frame in the second engaging state, and the second extension has a length that is greater than a length of the first extension.

In another optional form, the gate includes a first gate frame, a second gate frame, and at least one extension engaged therebetween in the first engaging state, and each extension has a uniform length. The number of the extensions in the second engaging state is more than the number of the extensions in the first state.

In another optional form, the frame includes a first end frame and a second end frame. Relative to the first engaging state, in the second engaging state the frame further includes an extension engaged between the first end frame and the second end frame.

In another optional form, the frame includes a first end frame and a second end frame, the frame further includes a first extension engaged between the first end frame and the second end frame in the first engaging state. The frame further includes a second extension engaged between the first end frame and the second end frame in the second engaging state. The second extension has a length that is greater than a length of the first extension.

In another optional form, the frame includes a first end frame, a second end frame, and at least one extension engaged therebetween. Each of the extensions has a uniform length. The number of the extensions in the second engaging state is more than the number of the extensions in the first engaging state.

In another optional form, the frame includes a first end frame and a second end frame, and the first end frame and the second end frame are configured to be telescopically engaged with one another in a length direction, and the barrier can be changed between the first engaging state and the second engaging state by telescopic adjustment.

In yet another aspect, a barrier as disclosed herein may include a frame having first end frame and a second end frame, and a gate having a first gate frame and a second gate frame. A first intermediate gate portion joins the first gate frame to the second gate frame in a first engaging state. A second intermediate gate portion joins the first gate frame to the second gate frame in a second engaging state. A length of the gate in the second engaging state is greater than a length of the gate in the first engaging state.

The foregoing example of a barrier may include any one or more of the following optional features, structures, and/or forms.

In one optional form, the second intermediate gate portion is an extending portion that is longer than the first intermediate gate portion.

In another optional form, the extending portion includes at least an upper member and a lower member and at least one tubular member between the upper member and the lower member.

In another optional form, a first frame intermediate portion joins the first end frame and the second end frame in the first engaging state, and a second frame intermediate portion joins the first end frame and the second end frame in the second engaging state, a length of the frame in the second engaging state being greater than a length of the frame in the first engaging state.

In another optional form, the second frame intermediate portion is an extending portion that is longer than the first frame intermediate portion.

Other features and advantages of the present invention will be described in the following specification, and some of these will become apparent from the description or be understood by implementing the present invention. The objectives and other advantages of the present invention can be implemented or obtained by structures specifically indicated in the written specification, claims, and accompanying drawings.

### BRIEF DESCRIPTION OF THE DRAWINGS

In order to illustrate the technical solutions in the embodiments of the present invention more clearly, the following briefly introduces the drawings required for the description of the embodiments. The drawings in the following description illustrate only some embodiments of the present invention.

FIG. 1A is a front view of a basic structure of a barrier where a frame connection between two end frames has been omitted but may be furnished by any one of the connections shown in FIGS. 4A, 7A, 7B, 7C, 7D, 8A, 8B, 9A, and 9B, and a gate connection between two gate frames has been omitted but may be furnished by any one of the connections shown in FIGS. 2A, 2B, 3A, 3B, 3C, 3D, 3E, 3F, 3G, 3H, 3I, 3J, 3K, 3L, 3M, 3N, 3R, 3S, 4A, 4B, 5A, 5B, 6A, and 6B.

FIG. 1B is an exploded front view of the basic structure of the barrier of FIG. 1A.

FIG. 2A is a perspective view of a gate connection of a first embodiment for the basic structure of the barrier of FIG. 1A.

FIG. 2B is an exploded perspective view of the gate connection of FIG. 2A.

FIG. 3A is a front view of a gate connection of a second embodiment for the basic structure of the barrier of FIG. 1A, some parts are omitted for simplicity.

FIG. 3B is an exploded front view of the gate connection of FIG. 3A.

FIG. 3C is a front view of a gate connection of a third embodiment for the basic structure of the barrier of FIG. 1A, some parts are omitted for simplicity.

FIG. 3D is an exploded front view of the gate connection of FIG. 3C.

FIG. 3E is a front view of a gate connection of a fourth embodiment for the basic structure of the barrier of FIG. 1A, with some parts omitted for simplicity.

FIG. 3F is an exploded front view of the gate connection of FIG. 3E.

FIG. 3G is a cross-sectional front view of the gate connection of FIG. 3E, with some parts omitted for simplicity.

FIG. 3H is a front view of a gate connection of a fifth embodiment for the basic structure of the barrier of FIG. 1A, with some parts omitted for simplicity.

FIG. 3I is an exploded front view of the gate connection of FIG. 3H.

FIG. 3J is a front view of a gate connection of a sixth embodiment for the basic structure of the barrier of FIG. 1A, with some parts omitted for simplicity.

FIG. 3K is an exploded perspective view of the gate connection of FIG. 3J.

FIG. 3L is a perspective view of a gate connection of a seventh embodiment for the basic structure of the barrier of FIG. 1A, with some parts omitted and some for simplicity.

FIG. 3M is a front view of a gate connection of an eighth embodiment for the basic structure of the barrier of FIG. 1A, with some parts omitted for simplicity.

FIG. 3N is an exploded perspective view of the gate connection of FIG. 3M.

FIG. 3R is a front view of a gate connection of a ninth embodiment for the basic structure of the barrier of FIG. 1A, with some parts omitted for simplicity.

FIG. 3S is an exploded perspective view of the gate connection of FIG. 3R.

FIG. 4A is a front view of a gate connection of a tenth embodiment and a frame connection of first embodiment for the basic structure of the barrier of FIG. 1A.

FIG. 4B is a perspective view of an extension for the gate connection of FIG. 4A.

FIG. 5A is a perspective view of a gate connection of an eleventh embodiment for the basic structure of the barrier of FIG. 1A.

FIG. 5B is an exploded perspective view of the gate connection of FIG. 5A.

FIG. 6A is a perspective view of a gate connection of a twelfth embodiment for the basic structure of the barrier of FIG. 1A.

FIG. 6B is a folded perspective view of the gate connection of FIG. 6A.

FIG. 7A is a perspective view of a frame connection of a second embodiment for the basic structure of the barrier of FIG. 1A, with some parts omitted for simplicity.

FIG. 7B is an exploded perspective view of the frame connection of FIG. 7A.

FIG. 7C is a perspective view of a frame connection of a third embodiment for the basic structure of the barrier of FIG. 1A, with some parts omitted for simplicity.

FIG. 7D is a perspective view of an extension for the frame connection of FIG. 4A and FIG. 7C.

FIG. 8A is a perspective view of a frame connection of a fourth embodiment for the basic structure of the barrier of FIG. 1A, with some parts omitted for simplicity.

FIG. 8B is an exploded perspective view of the frame connection of FIG. 8A.

FIG. 9A is a perspective view of a frame connection of a fifth embodiment for the basic structure of the barrier of FIG. 1A, with some parts omitted for simplicity.

FIG. 9B is a folded perspective view of the gate connection of FIG. 9A.

### DETAILED DESCRIPTION

In order to give clearer description of the technical problems to be solved, the details will be further described in below with reference to the accompanying figures. It should be understood that the specific embodiments described here are only used to explain the disclosed barrier, and the drawings and specific embodiments described herein are not intended to limit the scope of the disclosure. Rather, the scope of the disclosure is limited only by the claims set forth herein.

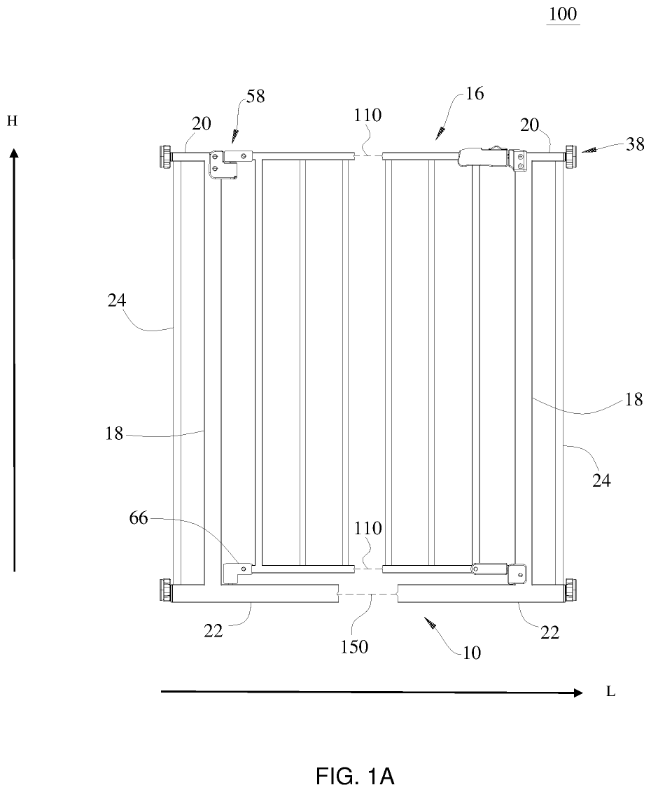

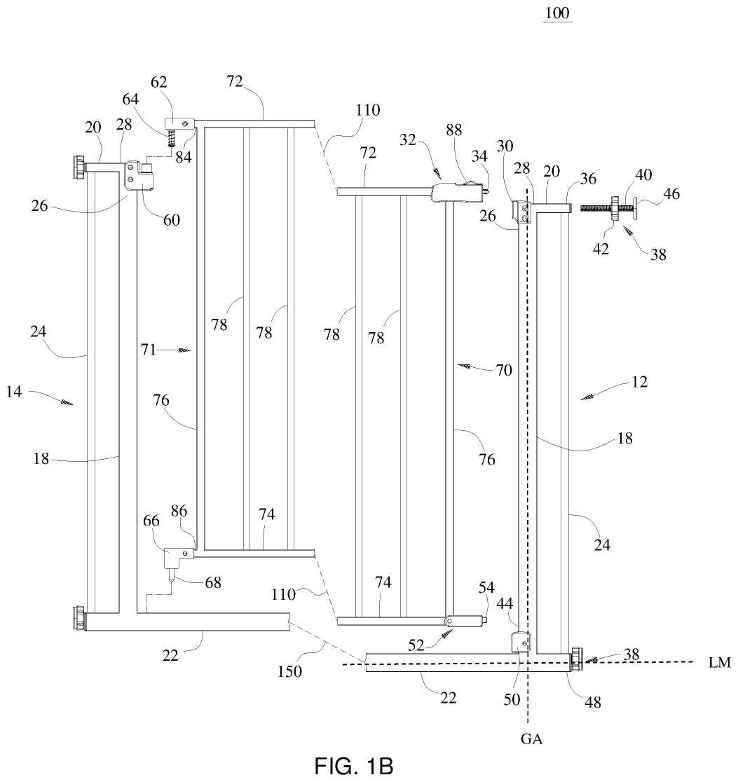

Turning to FIGS. 1A and 1B, a basic structure of an assembled gate or barrier is designated by reference numeral 100. The barrier 100 generally includes a frame 10 including a first end frame 12 and a second end frame 14, and a gate 16 engaged between the first end frame 12 and the second end frame 14. The barrier 100 includes a height direction H, a length direction defined L, for example, by a direction between two doorframes between which the barrier 100 is engaged, and a width or thickness direction (not shown in FIGS. 1A and 1B). The height, length and width (or thickness) directions are perpendicular to each other.

The first end frame 12 generally includes a gate adjacent member 18, an upper member 20, a lower member 22 and an end member 24. The gate adjacent member 18 is adjacent to the gate 16 (unless otherwise specified in the present invention, “adjacent” means that the two elements are adjacent to each other in the length direction, and there is no other structure is located between the two elements), which extends in the height direction between the upper member 20 and the lower member 22. The gate adjacent member 18 may be tubular, may be made of metal (or other strong material) such as steel or aluminum, and may be generally rectangular in cross-section in the illustrated embodiment. The gate adjacent member 18 includes an axis GA extending in the height direction, and the lower member 22 includes an axis LM extending inward from the gate adjacent member 18 in the length direction, and the two axes are inclined relative to each other. In other words, the angle between the two axes is slightly greater than 90 degrees, preferably between 90.5 degrees and 100 degrees, more preferably between 90.5 degrees and 95 degrees. An upper end portion 26 of the gate adjacent member 18 or an inner end portion 28 of the upper member 20 includes an upper locking slot 30 that can receive a latch 34 of an upper lock 32 of the gate 16, and a lower end portion 44 of the gate-adjacent member 18 includes a lower locking slot 50 that can receive a latch 54 of a lower lock 52 of the gate 16.

The upper member 20 extends outward in the length direction from the upper end portion 26 of the gate adjacent member 18. The upper member 20 may be tubular, may be made of metal (or other strong material) such as steel or aluminum, and may be generally rectangular in cross-section in the illustrated embodiment. The upper member 20 includes an outer end 36 that includes an opening (not shown in the drawings) for slidably receiving a pressurized arm 38 that can be adjusted along the length direction. The pressurized arm 38 includes a threaded shaft 40 that slidably engages the opening, a knurled wheel 42 threadedly engaged with the threaded shaft 40 rotates on the threaded shaft 40. A disc 46 fixed to an end of the threaded shaft 40 is for contacting and applying pressure to a position or surface such as a doorframe. In use, the knurled wheel 42 is rotated to travel toward and contact with the outer end 36, and continued rotation will move the threaded shaft 40 in an outward direction causing the disc 46 to apply pressure to the doorframe.

The lower member 22 extends inward and outward in the length direction from the lower end portion 44 of the gate adjacent member 18, and is substantially parallel to the upper member 20 when the barrier 100 is assembled. The lower member 22 may be tubular, may be made of metal (or other strong material) such as steel or aluminum, and may be generally rectangular in cross-section in the illustrated embodiment. The size of the rectangular cross section of the lower member 22 may be the same as that of the gate adjacent member 18. The lower member 22 includes an outer end 48 having an opening that slidably receives the other pressurized arm 38.

The end member 24 is distal to the gate 16 relative to the gate adjacent member 18, and the end member 24 extends in the height direction between the upper member 20 and the lower member 22, and two ends of the end member 24 are respectively engaged on the outer end 36 of the upper member 20 and the outer end 48 of the lower member 22. The end member 24 may be tubular, may be made of metal (or other strong material) such as steel or aluminum, and may be generally rectangular in cross-section in the illustrated embodiment.

The second end frame 14 is substantially the same as the first end frame 12 with the following exceptions:

1) A first exception is that the second end frame 14 includes, but the first end frame 12 does not include, an upper connector 58 for engaging the gate 16. The upper connector 58 includes a fixed portion 60 and a pivoted portion 62, and the fixed portion 60 is fixed to an upper end portion 26 of a gate adjacent member 18 of the second end frame 14 or an inner end portion 28 of an upper member 20 of the second end frame 14, for example, by means of rivets, and a pivoted portion 62 is pivotably attached to the gate 16, for example, by means of rivets. In other embodiments, other attachment mechanisms may be used to secure the fixed portion 60 and the pivoted portion 62. A pin 64 is engaged between the fixed portion 60 and the pivoted portion 62, and an axis of the pin 64 is coaxial with a pivot axis of the pivoted portion 62 and the gate 16.

2) A second exception is that the second end frame 14 includes, but the first end frame 12 does not include, a lower connector 66 for engaging the gate 16. A first end of the lower connector 66 is fixed to the gate 16, for example, by means of rivets, and a second end of the lower connector 66 is engaged on a lower member 22 of the second end frame 14 by a pin 68. In other embodiments, other attachment mechanisms may be used to fix the lower connector 66. An axis of the pin 68 is coaxial with the pivot axis of the lower connector 66 and the gate 16. The first end of the lower connector 66 is slightly higher than the second end, so that the gate 16 is slightly higher than the lower member 22 of the first end frame 12 and the second end frame 14.

3) A third exception is that an axis of the gate adjacent member 18 extending in the height direction and an axis of the lower member 22 of the second end frame 14 extending inward from the gate adjacent member 18 in the length direction are substantially at right angles. Although an angle slightly greater than 90 degrees may be provided here, this is not required.

4) A fourth exception is that the second end frame 14 does not include, but the first end frame 12 includes the upper locking slot 30 and the lower locking slot 50.

In other embodiments, the first end frame 12 and the second end frame 14 may have no upper member 20 and the end member 24.

The gate 16 includes a first gate frame 70 and a second gate frame 71. The first gate frame 70 is preferably formed of metal (or other strong material) such as steel or aluminum. The first gate frame 70 includes an upper member 72, a lower member 74, an end frame adjacent member 76, and several tubular members 78. The end frame adjacent member 76 and the tubular members 78 are engaged between the upper member 72 and the lower member 74, and the end frame adjacent member 76 is adjacent to the first end frame 12. The upper member 72, the lower member 74 and end frame adjacent member 76 may be tubular and rectangular in cross section, and the tubular members 78 may be cylindrical. In other embodiments, other cross-sectional shapes may be used. The first gate frame 70 includes an outwardly extending upper mounting member (which is not shown in the drawings but is covered by the upper lock 32) for mounting the upper lock 32, and the upper mounting member has a distal end with a sliding groove for receiving the latch 34, and the latch 34 can slide in the sliding groove. The upper mounting member is preferably formed of metal (or other strong material) such as steel or aluminum. The upper mounting member is rigidly fixed to the upper member 72 of the first gate frame 70 by welding, for example, and extends in the same common plane of the upper member 72, or in some embodiments the mounting member may extend outward integrally with the upper member 72. The first gate frame 70 includes an outwardly extending lower mounting member (covered by the lower lock 52 in the drawings, which is not shown) for mounting the lower lock 52. The lower mounting member is preferably formed of metal (or other strong material) such as steel or aluminum. The lower mounting member is rigidly fixed to the lower member 74 of the first gate frame 70 by welding, for example, and extends in the same common plane of the lower member 74, or extends outward integrally with the lower member 74.

The second gate frame 71 is substantially the same as the first gate frame 70, with the following exceptions:

1) A first exception is that, unlike the upper mounting member of the first gate frame 70, an upper mounting member 84 of the second gate frame 71 is used to engage the pivoted portion 62 of the upper connector 58. The upper mounting member 84 is preferably formed of metal (or other strong material) such as steel or aluminum. The upper mounting member 84 is rigidly fixed to the upper member 72 of the second gate frame 71, for example by welding, and extends in the same common plane of the upper member 72, or in other embodiments, the upper mounting member 84 may extend outward integrally with the upper member 72.

2) A second exception is that, unlike the lower mounting member of the first gate frame 70, a lower mounting member 86 of the second gate frame 71 is used to engage the lower connector 66. The lower mounting member 86 is preferably formed of metal (or other strong material) such as steel or aluminum. The lower mounting member 86 is rigidly fixed to the lower member 74 of the second gate frame 71, for example by welding, and extends outward in the same common plane of the lower member 74, or in other embodiments, the lower mounting member 86 may extend outward integrally with the lower member 74.

The upper lock 32 includes a slide switch 88 that slides along a slide slot (not shown in the drawings) on a main body of the upper lock 32, and the slide switch 88 is engaged to the latch 34 to allow the latch 34 to slide into or out of the upper locking slot 30 by sliding. When the latch 34 slides out of the upper locking slot 30, the pivoted portion 62 of the upper connector 58 can be lifted to a certain height along the axis of the pin 64, and the lower connector 66 can be lifted to a certain height along the axis of the pin 68, which allows the gate 16 as a whole to be lifted to a certain height so that the latch 54 can leave the lower locking slot 50 from the upper opening of the lower locking slot 50. The gate 16 can be opened when the latch 54 is leave from the lower locking slot 50.

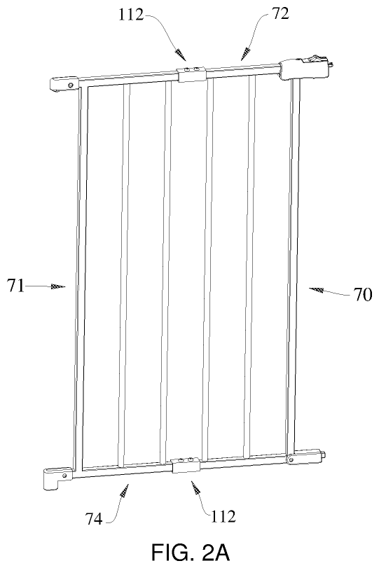

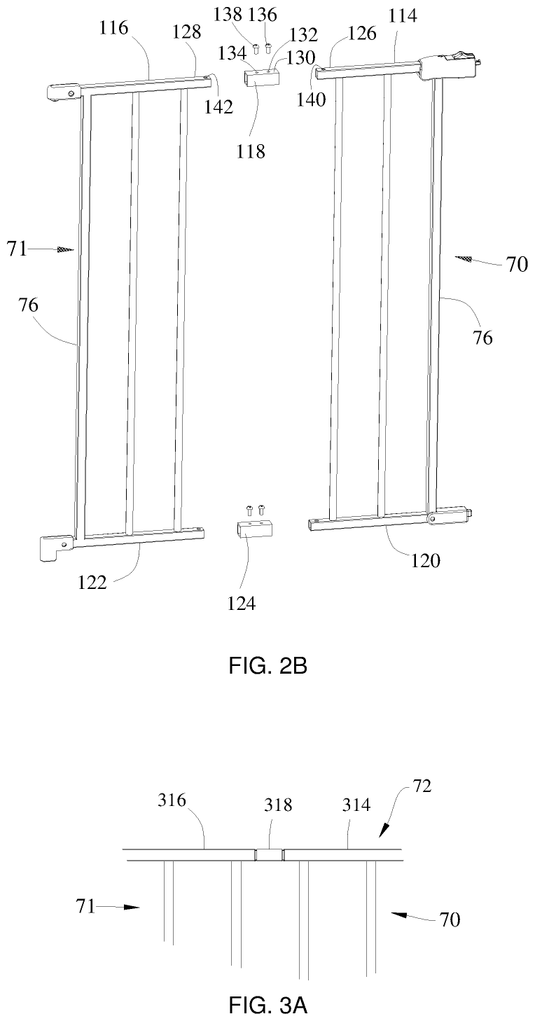

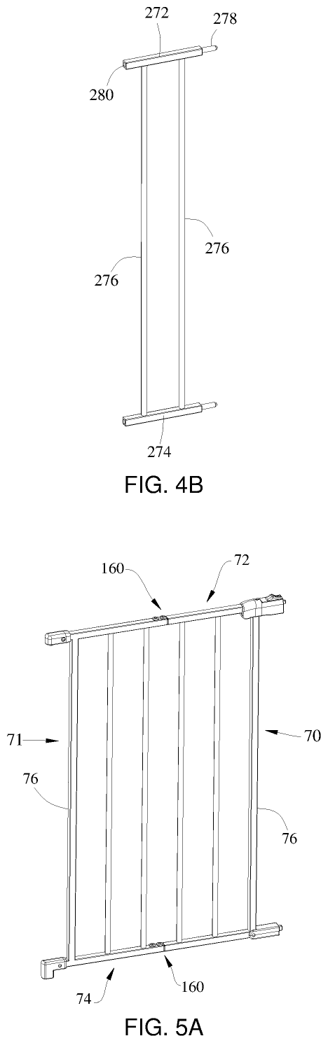

FIGS. 1A and 1B include phantom lines indicated by reference numbers 110 and 150. The phantom lines indicate that different connection methods can be formed, for example, the phantom line 110 may take the form by any one of gate connections shown in FIGS. 2A, 2B, 3A, 3B, 3C, 3D, 3E, 3F, 3G, 3H, 3I, 3J, 3K, 3L, 3M, 3N, 3R, 3S, 4A, 4B, 5A, 5B, 6A, and 6B, the phantom line 150 may take the form by any one of frame connections shown in FIGS. 4A, 7A, 7B, 7C, 7D, 8A, 8B, 9A, and 9B. Generally, any one of the frame connections of the phantom line 150 shown in FIGS. 4A, 7A, 7B, 7C, 7D, 8A, 8B, 9A, and 9B is used in combination with the any one of the gate connections of the phantom line 110 shown in FIGS. 2A, 2B, 3A, 3B, 3C, 3D, 3E, 3F, 3G, 3H, 3I, 3J, 3K, 3L, 3M, 3N, 3R, 3S, 4A, 4B, 5A, 5B, 6A, and 6B, or only use the any one of the frame connections of the phantom line 150 shown in FIGS. 4A, 7A, 7B, 7C, 7D, 8A, 8B, 9A, and 9B, both of which can reduce the package size of the barrier 100 and facilitate transportation and storage. Of course, it is also possible to use only the any one of the gate connections of the phantom line 110 shown in FIGS. 2A, 2B, 3A, 3B, 3C, 3D, 3E, 3F, 3G, 3H, 3I, 3J, 3K, 3L, 3M, 3N, 3R, 3S, 4A, 4B, 5A, 5B, 6A, and 6B, which can reduce the package size of the gate 16 and facilitate the transportation and storage of the gate 16 alone.

FIGS. 2A and 2B show a gate connection 112 of the phantom line 110 for the basic structure of FIGS. 1A and 1B. The gate connection 112 includes the upper member 72 and the lower member 74. The upper member 72 includes a member portion 114 engaged to the first gate frame 70, a member portion 116 engaged to the second gate frame 71, and an intermediate member portion 118 located between and engaged to the member portions 114,116. The lower member 74 includes a member portion 120 engaged to the first gate frame 70, a member portion 122 engaged to the second gate frame 71, and an intermediate member portion 124 located between and engaged to the member portions 120, 122. Lengths of the member portions 114, 120 are substantially equal, and lengths of the member portions 116, 122 are substantially equal. It is preferable that the lengths of the member portions 114, 116, 120, 122 are substantially equal to minimize the size of the carton for packaging or storing the gate 16. The member portions 114, 116, 120, 122 and the intermediate member portions 118, 124 may be tubular. In other embodiments, other shapes may be used. Both ends of the intermediate member portions 118, 124 include sleeves. The intermediate member portion 118 is engaged with the member portions 114, 116 by receiving an inner end 126 of the member portion 114 and an inner end 128 of the member portion 116 into the sleeves at both ends. The inner end 126 and the member portion 114 are integrated and have substantially the same width and height. The inner end 128 and the member portion 116 are integral and have substantially the same width and height, and a width and height of the intermediate member portion 118 are slightly larger than those of the inner ends 126, 128 so that the inner ends 126, 128 can be received in the sleeve by friction fit. A top wall 130 (which can also be a side wall or a bottom wall) of the intermediate member portion 118 includes horizontally aligned holes 132, 134 for receiving pins 136, 138. The inner end 126 has a hole 140 which can be aligned with the hole 132, and the inner end 128 has a hole 142 which can be aligned with the hole 134. The pins 136, 138 engage the inner ends 126, 128 with the intermediate member portion 118 to form a joint on the upper member 72 after the inner ends 126, 128 are slid into the intermediate member portion 118. The inner ends 126, 128 may face or contact each other after engaging. A length of the gate 16 is substantially equal to the sum of the lengths of the member portions 114, 116 or the member portions 120, 122 if the inner ends 126, 128 are in contact, and the length of the gate 16 is greater than the sum of the lengths of the member portions 114, 116 or the member portions 120, 122 if the inner ends 126, 128 are not in contact. Removal is facilitated when the pins 136, 138 are screws, or the member portions 114, 116, 118 can be engaged substantially permanently when the pins 136, 138 are rivets. It should be understood that the number of pins and holes is merely illustrative. In the same manner, the intermediate member portion 124 engages the member portions 120, 122 to form a joint on the lower member 74.

As an example, the intermediate member portion 118 may also be integrally provided with one of the member portions 114, 116 by welding, instead of using a pin-hole connection, and the other is still provided in a separate manner. Similarly, the second intermediate member portion 124 can also adopt this way.

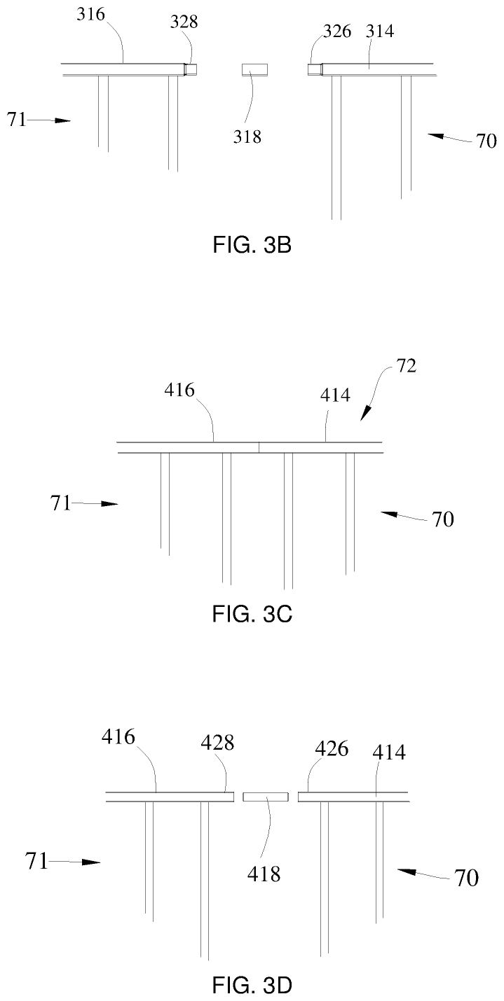

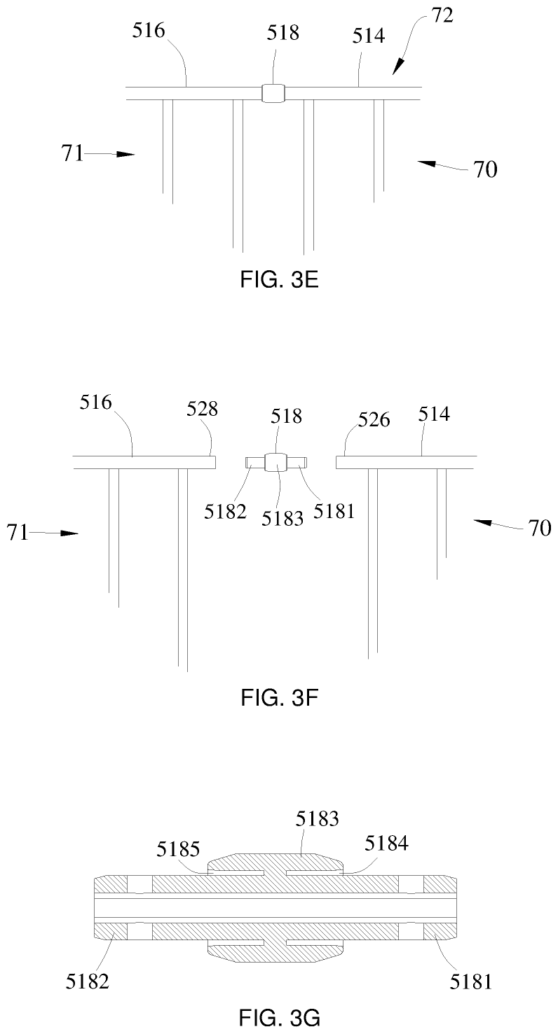

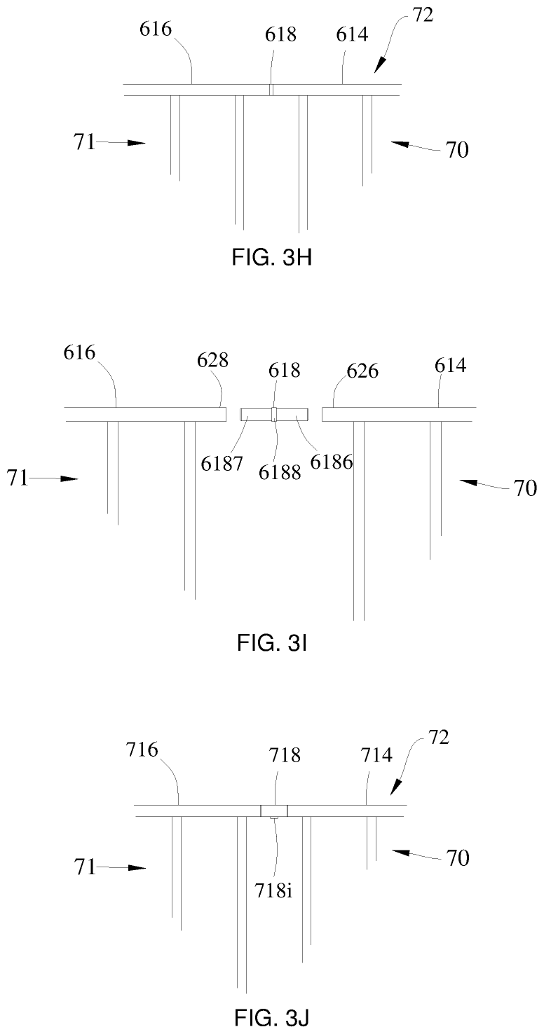

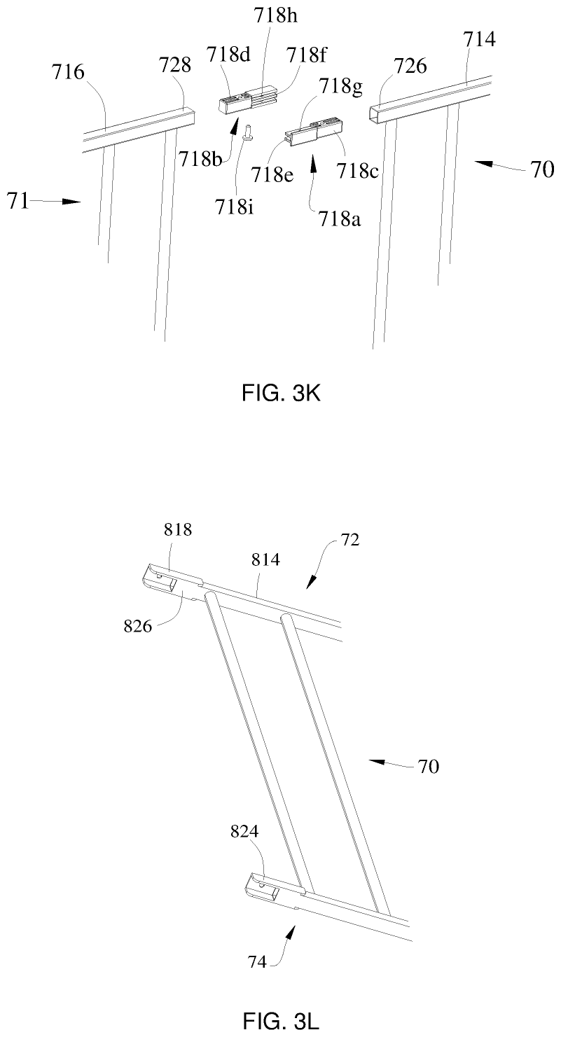

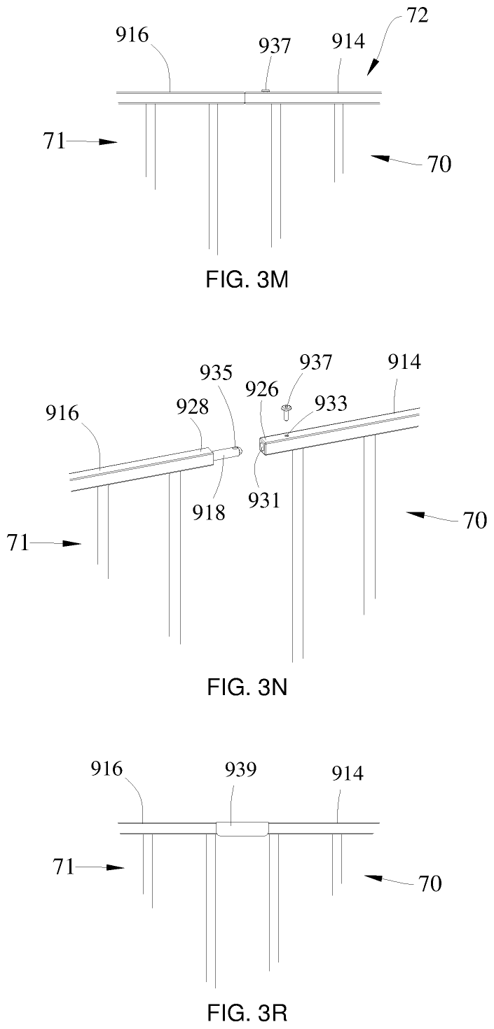

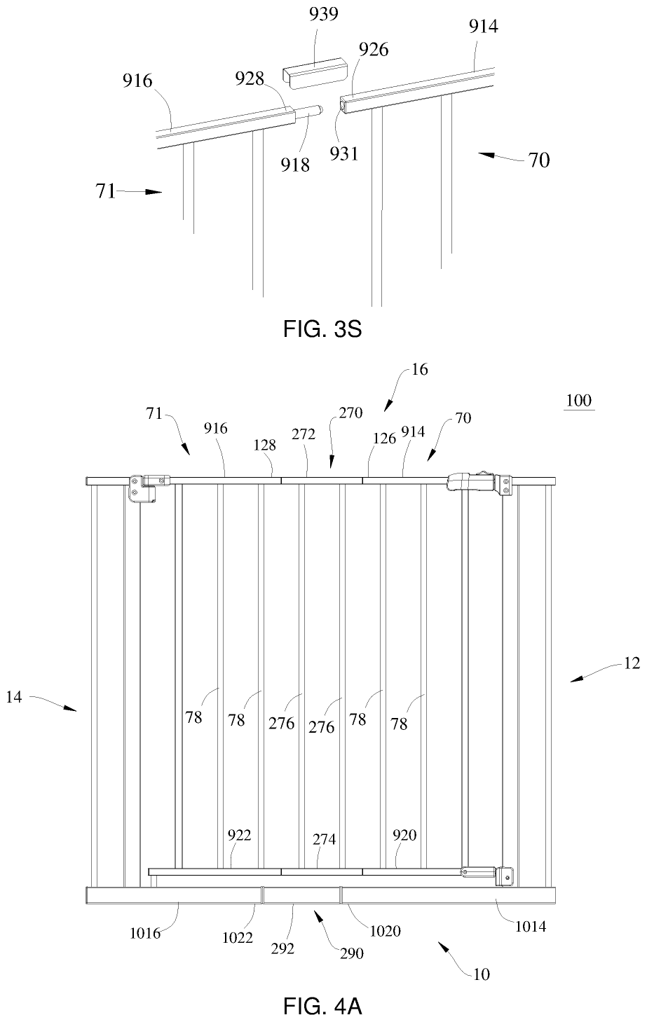

Turning to FIGS. 3A and 3B, an intermediate member portion 318 may also have substantially the same width and height as a member portion 314 of the first gate frame 70 and a member portion 316 of the second gate frame 71. While a width and height of inner ends 326, 328 of the member portions 314, 316 may be slightly smaller than those of the member portions 314, 316, 318 so that the inner ends 326, 328 can be received in the sleeves at both ends of the intermediate member portion 318 with a friction fit and without forming a joint on the upper member 72, that is, the outer surfaces of the member portions 314, 316, 318 are substantially flat after engaging. Similarly, an intermediate member portion (not shown in the drawings) engaged with the lower member 74 can also engage this way. The arrangement of pins and holes may be the same as in the embodiment of FIGS. 2A and 2B.

Turning to FIGS. 3C and 3D, a width and height of an intermediate member portion 418 may also be smaller than a width and height of a member portion 414 of the first gate frame 70 and a member portion 416 of the second gate frame 71. While inner ends 426, 428 of the member portions 414, 416 have substantially the same width and height as the member portions 414, 416 and both the inner ends 426, 428 have sleeves so that the intermediate member portion 418 can be received in the sleeves of the inner ends 426, 428 with a friction fit and without forming a joint on the upper member 72, that is, the inner ends 426, 428 may face or contact each other after engaging. The intermediate member portion 418 is substantially inside and invisible, and the outer surfaces of the member portions 414, 416 are substantially flat if the inner ends 426, 428 are in contact. Similarly, an intermediate member portion (not shown in the drawings) engaged with the lower member 74 can also engage this way. The arrangement of pins and holes may be the same as in the embodiment of FIGS. 2A and 2B.

Turning to FIGS. 3E, 3F and 3G, an intermediate member portion 518 may include two outer ends 5181, 5182 having widths and heights smaller than those of a member portion 514 of the first gate frame 70 and a member portion 516 of the second gate frame 71, and a middle portion 5183 having a width and height greater than those of the member portions 514, 516. Both ends of the middle portion 5183 have sleeves, the outer ends 5181, 5182 are connected to the middle portion 5183 inside the middle portion 5183 and extend outwards so as to protrude out of the sleeve. Gaps 5184 and 5185 around the outer ends 5181 and 5182 are formed between the inner surface of the sleeve and the outer surfaces of the outer ends 5181 and 5182. Inner ends 526, 528 of the member portions 514, 516 have substantially the same width and height as the member portions 514, 516 and the inner ends 526, 528 both have sleeves, and the thickness of the inner ends 526, 528 is smaller than a width of the gaps 5184, 5185. After engagement, the outer ends 5181, 5182 are received in the sleeves of the inner ends 526, 528 and the inner ends 526, 528 are received in the gaps 5184, 5185 to form a joint on the upper member 72. Similarly, an intermediate member portion (not shown in the drawings) may be engaged with the lower member 74 can also engage this way. The arrangement of pins and holes may be the same as in the embodiment of FIGS. 2A and 2B. Generally, holes are provided at the two outer ends 5181, 5182. In this way, the connection firmness of the gate connection 112 can be enhanced.

Turning to FIGS. 3H and 3I, an intermediate member portion 618 may include two outer ends 6186, 6187 having widths and heights less than those of a member portion 614 of the first gate frame 70 and a member portion 616 of the second gate frame 71, and a middle portion 6188 having a width and height substantially equal to the member portions 614, 616. Inner ends 626, 628 of the member portions 614, 616 have substantially the same width and height as the member portions 614, 616 and both the inner ends 626, 628 have sleeves such that the outer ends 6186, 6187 are received by the inner ends 626, 628. After engagement, the inner ends 626, 628 both face or contact the middle portion 6188, so that no joint is formed on the upper member 72. The rest of the intermediate member portion 618 except the middle portion 6188 is substantially located inside and invisible if the inner ends 626, 628 are in contact. Similarly, an intermediate member portion (not shown in the drawings) that may be engaged with the lower member 74 can also engage this way. The arrangement of pins and holes may be the same as in the embodiment of FIGS. 2A and 2B. Generally, holes are provided at the two outer ends 6186, 6187. In this way, the pins and holes can be aligned only by inserting the inner ends 626, 628 into contact with the middle portion 6188.

Turning to FIGS. 3J and 3K, an intermediate member portion 718 may include a first portion 718a and a second portion 718b which are detachably connected. A width and height of an outer end 718c of the first portion 718a are smaller than those of a member portion 714 of the first gate frame 70 and a member portion 716 of the second gate frame 71, and a width and height of an outer end 718d of the second portion 718b are smaller than those of the member portions 714 and 716. An inner end 718e of the first portion 718a is one of tenon or mortise, and an inner end 718f of the second portion 718b is the other one of tenon or mortise. Inner ends 726, 728 of the member portions 714, 716 have substantially the same width and height as the member portions 714, 716 and both the inner ends 726, 728 have sleeves. After engagement, the outer end 718c is received in the sleeve of the inner end 726, the outer end 718d is received in the sleeve of the inner end 728, and the inner ends 718e, 718f are connected. It is possible to form no joint (as shown in FIG. 3J) or a joint (not shown) on the upper member 72 by setting the dimensions of the inner ends 718e, 718f. After engagement, the inner ends 726, 728 respectively contact with the inner ends 718e, 718f. Similarly, an intermediate member portion (not shown in the drawings) that may be engaged with the lower member 74 can also engage this way. Pins and holes provided at the outer ends 718c, 718d can be the same as those in the embodiment of FIGS. 2A and 2B. In addition to this, further includes alignable holes 718g, 718h provided on the inner ends 718e, 718f for receiving a pin 718i that engage the inner ends 718e, 718f.

Turning to FIG. 3L, an intermediate member portion 818 may also be a U-shaped channel piece without a full surround and the intermediate member portion 818 engages with a member portion 814 of the first gate frame 70 by receiving an inner end 826 of the member portion 814 into the U-shaped channel piece. Similarly, the intermediate member portion 818 may also engage with the second gate frame (not shown) in this way, so as to form a joint on the upper member 72. In a similar manner, an intermediate member portions 824 may be engaged with the lower member 74. One of the intermediate member portions 818, 824 may be integrally provided with one of the first gate frame 70 and the second gate frame, for example by welding, instead of using a pin-and-hole connection, and with the other one of the first gate frame 70 and the second gate frame still adopt a separate arrangement such as pin-hole connection.

Turning to FIGS. 3M and 3N, an intermediate member portion 918 may also be a rod fixed to an inner end 928 of a member portion 916 of the second gate frame 71 along the length direction, an inner end 926 of a member portion 914 of the first gate frame 70 has an opening 931 to receive the free end of the intermediate member portion 918, the intermediate member portion 918 can slide into the opening 931. After the intermediate member portion 918 is slid into the opening 931, the inner ends 926, 928 face or contact each other, and the intermediate member portion 918 is substantially inside and not visible when contacted. The inner ends 926, 928 may have substantially the same width and height as the member portions 914, 916 so that no joints are formed on the upper member 72. The gate frames 70, 71 may be firmly engaged together under the pressure of the doorframes on both sides. Alignable holes 933, 935 may further be provided on the inner end 926 and the intermediate member portion 918 for receiving pins 937 that may reinforce the engagement between the inner end 926 and the intermediate member portion 918. Alternatively, turning to FIGS. 3R and 3S, a U-shaped channel member 939 can be provided, and the inner ends 926, 928 can be received in the U-shaped channel member 939 to enhance the firmness of the engagement of the inner ends 926, 928. As an example, the U-shaped channel member 939 can be integrally formed with one of the member portions 914, 916 by welding, or it can be set as a separate body. When the U-shaped channel member 939 is set as a separate body, the U-shaped channel member 939 can be made of metal or hard plastic (or other strong materials). The U-shaped channel member 939 is generally made of substantially the same material as the member portions 914, 916 when provided in one piece. The pin-hole and the U-shaped channel member can be provided at the same time, and the separate U-shaped channel member 939 can also be fixed to one of the member portions 914, 916 by providing holes that can be aligned with the holes 933, 935. Similarly, an intermediate member portion (not shown in the drawings) engaged with the lower member 74 can also adopt the above-mentioned manner. It should be understood that the arrangement positions of the intermediate member portion 918 and the opening 931 can be reversed, that is, the intermediate member portion 918 is fixed to the inner end 926 while the opening 931 is arranged at the inner end 928.

Turning to FIGS. 4A and 4B, on the basis of the embodiments of FIGS. 3M and 3N or FIGS. 3R and 3S, the length of the gate 16 is extended by providing an extension 270. The extension 270 includes an upper member 272, a lower member 274, and at least one tubular member 276 (two tubular members 276 are exemplified in FIG. 4, but there may be more or less than two tubular members 276). The tubular member 276 is engaged between the upper member 272 and the lower member 274. The upper member 272 and the lower member 274 may be tubular and rectangular in cross-section (in other embodiments, other cross-sectional shapes may be used). The upper member 272 may have a same width and height as the member portions 914, 916. The lower member 274 may have substantially the same width and height as a member portion 920 of the first gate frame 70 and a member portion 922 of the second gate frame 71. The tubular member 276 may be cylindrical (in other embodiments, other shapes may be used). The upper member 272 and the lower member 274 extend along the length direction and are arranged substantially parallel to each other, and the tubular member 276 extends in the height direction. The upper member 272 has a rod 278 fixed at one end and an opening 280 at the other end. The rod 278 can be slid into the opening 931 of the inner end 926, and the opening 280 can receive the intermediate member portion 918, thereby engaging the upper member 272 between the member portions 914, 916. Similarly, the lower member 274 may engage in the above-mentioned manner, in which the extension 270 is engaged between the first gate frame 70 and the second gate frame 71, thereby extending the length of the gate 16. The tubular members 276 are arranged such that when the extension 270 is engaged between the first gate frame 70 and the second gate frame 71, the distance between the adjacent tubular member 276 and the tubular member 78 is substantially equal to the distance between the adjacent two tubular member members 78, and the distance between the adjacent two tubular members 276 when there are multiple members 276. In this way, the tubular members 78 and the tubular members 276 are substantially uniformly and substantially equidistantly arranged. The extension 270 with different numbers of the tubular members 276 allows the gate 16 to extend for different lengths. It is also possible to extend the length of the gate 16 by engaging the first gate frame 70 and the second gate frame 71 through a plurality of the extensions 270 in the order of rod-opening-rod-opening engagement. The pins and holes in the embodiment of FIGS. 3M and 3N or the U-shaped channel member in the embodiment of FIGS. 3R and 3S can also be applied to the connection between the extension 270 and the first gate frame 70 or the second gate frame 71, or the connection between two adjacent extensions 270, so as to enhance the firmness of the connection, which will not be described here.

On the basis of FIG. 2A, 2B or 3A, 3B or 3C, 3D or 3E, 3F, 3G or 3H, 3I or 3J, 3H or 3L, the length of the gate 16 can be extended by providing an extension. The main part of the extension can refer to the embodiment of FIGS. 4A and 4B. Besides, It is only necessary to construct the ends of the extensions engaged to the gate frames 70, 71 to be the same as the inner ends of the member portions 114, 116, 120, 122, 314, 316, 414, 416, 514, 516, 614, 616, 714, 716, 814, 816, 914, 916 of the gate frames 70, 71 and then use the intermediate member portions at the joints of the extensions and the gate frames 70, 71, so as to engage the extensions between the gate frames 70, 71, and it is also possible to use intermediate member portions to engage two adjacent extensions, and each joint is provided with an intermediate member portion.

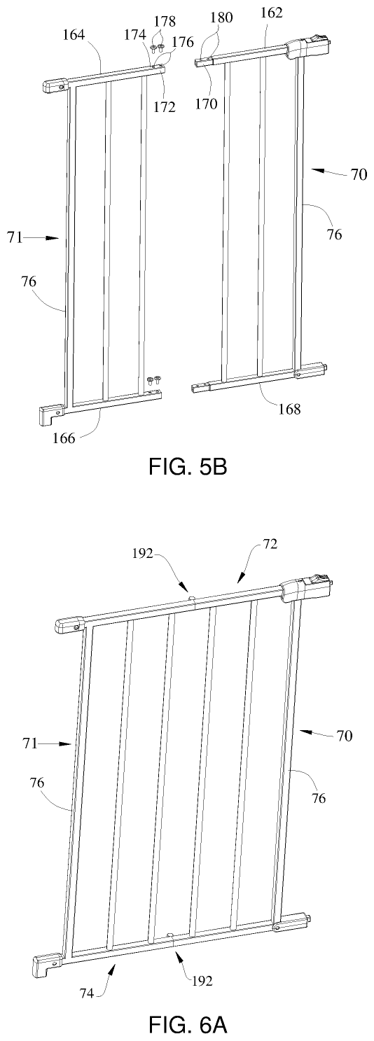

FIGS. 5A and 5B show a gate connection 160 of the phantom line 110 for the basic structure of FIGS. 1A and 1B. The gate connection 112 includes the upper member 72 and the lower member 74. The upper member 72 includes a member portion 162 engaged to the first gate frame 70, a member portion 164 engaged to the second gate frame 71. The lower member 74 includes a member portion 166 engaged to the first gate frame 70, a member portion 168 engaged to the second gate frame 71. The lengths of the member portions 162, 166 are substantially equal, and the lengths of the member portions 164, 168 are substantially equal. It is preferable that the lengths of the member portions 162, 164, 166, 168 are substantially equal to minimize the size of the carton for packaging or storing the gate 16. The member portions 162, 164, 166, 168 may be tubular. An inner end 172 of the member portion 164 is integral with the member portion 164 and has substantially the same width and height, while a width and height of an inner end 170 of the member portion 162 are slightly smaller than the width and height of the inner end 172, this allows the inner end 170 to be received in the inner end 172 with a friction fit without forming a joint on the upper member 72, that is, the outer surfaces of the member portions 162, 164 are substantially flat after engaging. A top wall 174 (which can also be a side wall or a bottom wall) of the inner end 172 includes a pair of substantially horizontally aligned holes 176 for receiving a pair of pins 178, and the inner end 170 includes a pair of substantially horizontally aligned holes 180. When the inner end 170 slides into the inner end 172, the holes 176 and 180 can be aligned, and the pins 178 engages the inner ends 170, 172. Removal is facilitated when the pins 178 are screws, or the member portions 162, 164 can be engaged substantially permanently when the pins 178 are rivets. It should be understood that the number of pins and holes is merely illustrative. In the same manner, the member portions 166, 168 can be engaged without forming a joint on the lower member 74, that is, the outer surfaces of the member portions 166, 168 are substantially flat after engaging.

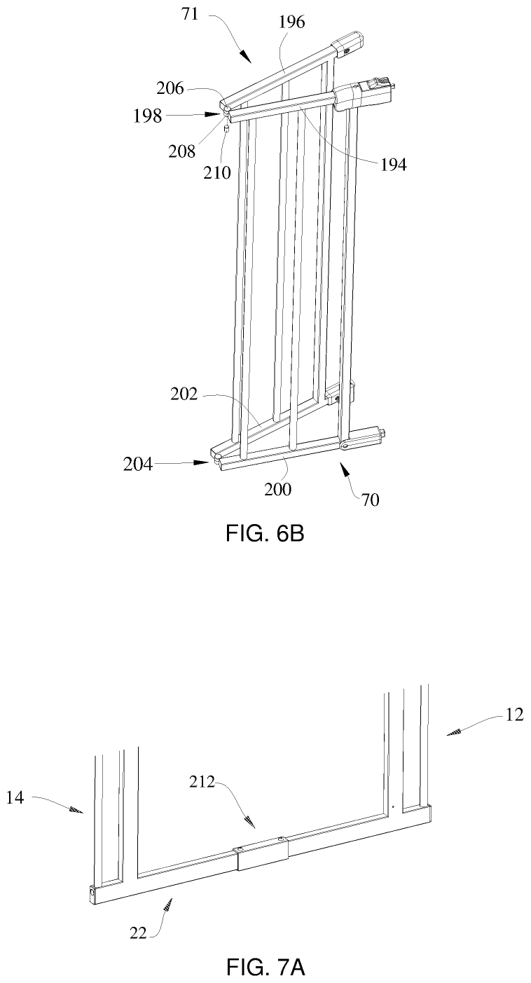

FIGS. 6A and 6B show a gate connection 192 of the phantom line 110 for the basic structure of FIGS. 1A and 1B. The gate connection 192 includes the upper member 72 and the lower member 74. The upper member 72 includes a member portion 194 engaged to the first gate frame 70, a member portion 196 engaged to the second gate frame 71, and an intermediate member portion 198 located between and engaged to the member portions 194,196. The lower member 74 includes a member portion 200 engaged to the first gate frame 70, a member portion 202 engaged to the second gate frame 71, and an intermediate member portion 204 located between and engaged to the member portions 200, 202. It is preferable that the lengths of the member portions 194, 196, 200, 202 are substantially equal to minimize the size of the carton for packaging or storing the gate 16. The member portions 194, 196, 200, 202 may be tubular. The intermediate member portions 198, 204 include articulated joints. The intermediate member portion 198 includes a first portion 206 engaged or integral with the member portion 194, a second portion 208 engaged or integral with the member portion 196, the first portion 206 and the second portion 208 can rotate relative to each other, and engage with each other by a pin 210 to form the articulated joint that includes an axis that is substantially parallel to the swinging axis of the gate 16. The intermediate member portion 198 may include a locking mechanism (not shown in the drawings) which can be moved to a locked position to prevent the member portions 194, 196 from rotating relative to each other when the member portions 194, 196 are aligned with each other in a substantially straight line, and the locking mechanism can be moved from the locked position to the unlocked position, so that the member portions 194, 196 can be rotated to a folded position facing each other. In the same manner, the intermediate member portion 204 allows the member portions 200, 202 to swing relative to each other into a folded position facing each other so that the gate 16 can be packaged in a carton in a folded manner, which is convenient for transportation.

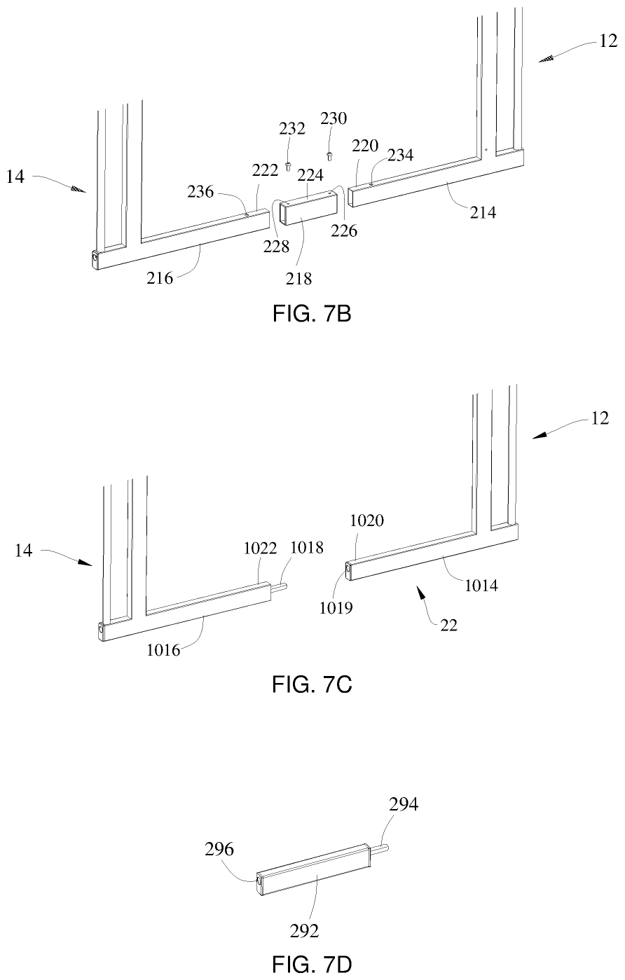

FIGS. 7A and 7B show a frame connection 212 of the phantom line 150 for the basic structure of FIGS. 1A and 1B. The frame connection 212 includes the lower member 22. The lower member 22 includes an end member portion 214 engaged to the first end frame 12, an end member portion 216 engaged to the second end frame 14, and an intermediate end member portion 218 located between and engaged to the end member portions 214,216. Preferably, a length of each end member portion 214, 216, 218 is substantially equal to or less than the length of the gate 16, so as to reduce the size of the carton for packaging or storing the barrier 100. It is most preferable that the length of each end member portion 214, 216, 218 is substantially equal to or less than the length of each member portion of the gate 16, so as to minimize the size of the carton for packaging or storing the barrier 100. The end member portions 214, 216, 218 may be tubular. The intermediate end member portion 218 includes sleeves at both ends, which are engaged with the end member portions 214, 216 by receiving an inner end 220 of the end member portion 214 and an inner end 222 of the end member portion 216 into the sleeves at both ends, respectively. The inner end 220 is integral with the end member portion 214 and has substantially the same width and height, while the inner end 222 is integral with the end member portion 216 and has a same width and height. A width and height of the intermediate end member portion 218 are slightly larger than those of the inner ends 220, 222, so that the inner ends 220, 222 can be received in the sleeve by a friction fit. A top wall 224 (which can also be a side wall) of the intermediate end member portion 218 includes substantially horizontally aligned holes 226, 228 for receiving pins 230, 232. The inner end 220 has a hole 234 which can be aligned with the hole 226, and the inner end 222 has a hole 236 which can be aligned with the hole 228. The pins 230, 232 engage the inner ends 220, 222 with the intermediate end member portion 218 to form a joint on the lower member 22 after the inner ends 220, 222 are slid into the intermediate end member portion 218. The inner ends 220, 222 may face or contact each other after engaging. A length of the frame 10 is substantially equal to the sum of the lengths of the end member portions 214, 216 if the inner ends 220, 222 are in contact, and the length of the frame 10 is greater than the sum of the lengths of the member portions 214, 216 if the inner ends 220, 222 are not in contact. Removal is facilitated when the pins 230, 232 are screws, or the end member portions 214, 216, 218 can be engaged substantially permanently when the pins 230, 232 are rivets.

An extending portion (not shown in the figure) may also be included between the sleeves at both ends of the intermediate end member portion 218, which has substantially the same width and height as the end member portions 214, 216. The extending portion may be used to extend the length of the intermediate end member portion 218, and correspondingly reduce the length of the end member portions 214, 216 so that the length of the frame 10 can be substantially evenly distributed to the end members 214, 216, 218 to minimize the size of the carton for packaging or storing the barrier 100. The sleeves and the extension portion can be integrated, for example, by welding, or can be separately arranged and engaged by pin holes.

As an example, the intermediate end member portion 218 can also be integrally provided with one of the end member portions 214, 216 by welding, instead of using a pin-hole connection, and the other is still provided in a separate manner.

The intermediate end member portion 218 can also have a width and height substantially the same as the end member portions 214, 216, while a width and height of the inner ends 220, 222 are slightly smaller than those of the end member portions 214, 216, 218 so that the inner ends 220, 222 can be received in the sleeves in a friction fit without forming a joint on the lower member 22, that is, the outer surfaces of the end member portions 214, 216, 218 are substantially flat after engaging. This manner and the arrangement of pin-hole connection can be referred to the embodiment of the gate connection of FIGS. 3A and 3B, and will not be illustrated again.

A height and width of the intermediate end member portion 218 may be slightly smaller than those of the end member portions 214, 216 and a width and height of the inner ends 220, 222 provided with sleeves are equal to those of the end member portions 214, 216 so that the intermediate end member portion 218 can be received in the sleeves in a friction fit without forming a joint on the lower member 22, that is, the intermediate end member portion 218 is substantially located inside after engaging. This manner and the arrangement of pin-hole connection can be referred to the embodiment of the gate connection of FIGS. 3C and 3D, and will not be illustrated again.

The intermediate end member portion 218 can also be a U-shaped channel piece without full surround, which is engaged with the end member portions 214, 216 by receiving the inner ends 220, 222 into the U-shaped channel piece, respectively. Preferably, when the barrier 100 is assembled, the U-shaped channel piece is engaged in an inverted U-shaped direction, so that the lower surface of the lower member 22 is substantially flat and can be closely attached to the ground. As an example, the U-shaped channel piece can be integrally provided with one of the end member portions 214, 216 by welding, instead of using pin-hole connection, and the other is still provided in a separate manner. This manner and the arrangement of U-shaped channel piece can be referred to the embodiment of the gate connection of FIG. 3L, and will not be illustrated again.

The intermediate end member portion 218 can also adopt the embodiment of the intermediate member portions as shown in FIGS. 3E, 3F, 3G, 3H, 3I, 3J and 3K, which will not be illustrated and described in detail here.

Turning to FIG. 7C, an intermediate end member portion 1018 may also be a rod fixed to an inner end 1022 of an end member portion 1016 of the second end frame 14 along the length direction, an inner end 1020 of an end member portion 1014 of the first frame 12 has an opening 1019 that receives the free end of the intermediate end member portion 1018. The intermediate end member portion 1018 can slide into the opening 1019. After the intermediate end member portion 1018 is slid into the opening 1019, the inner ends 1020, 1022 face or contact each other. The intermediate end member portion 1018 is substantially located inside and invisible of the inner ends 1020, 1022 that are in contact. The inner ends 1020, 1022 may have substantially the same width and height as the end member portions 1014, 1016 so that no joint is formed on the lower member 22. The end frames 12, 14 may be firmly engaged together under the pressure of the doorframes on both sides. It is also possible to refer to the embodiment of the gate connection of FIG. 3M, 3N or 3R, 3S to further strengthen the firmness of the connection of the end member portion 1014, 1016 by means of pin-hole connection or U-shaped channel piece, which will not be illustrated and described in detail here. It should be understood that the positions of the intermediate end member portion 1018 and the opening 1019 can be reversed, that is, the intermediate end member portion 1018 is fixed to the inner end 1020 and the opening 1019 is arranged at the inner end 1022.

Turning to FIGS. 4A and 7D, based on the embodiment of FIG. 7C, the length of the frame 10 is extended by providing an extension 290. The extension 290 includes a tubular member 292, the cross section of which may be rectangular (or other shapes in other embodiments), and the tubular member 292 may have substantially the same width and height as the end member portions 1014, 1016. The tubular member 292 extends along the length direction. One end of the tubular member 292 is fixed with a rod 294, and the other end has an opening 296. The rod 294 can slide into the opening 1019, and the opening 296 can receive the intermediate end member portion 1018, thereby engaging the extension 290 between the end frames 12, 14 to extend the length of the frame 10. The extension 290 with different lengths of the tubular member 292 allows the frame 10 to extend for different lengths. It is also possible to extend the length of the frame 10 by engaging the end frames 12, 14 through a plurality of the extensions 290 in the order of rod-opening-rod-opening engagement. The pin-hole connection in the embodiment of FIGS. 3M, 3N or the U-shaped channel member in the embodiment of FIGS. 3R, 3S can also be applied to the connection between the extension 290 and the end frame 12 or the end frame 14, or the connection between two adjacent extensions 290, so as to enhance the connection firmness, which is not illustrated or described in detail here.

The frame 10 can also be reduced in size in a telescopic way, for example, a width and height of one of end member portions can be smaller than a width and height of the other one, so that the one of the end member portions can be received and slid in the other one, and the size of the frame 10 can be reduced by making the end member portions close to each other. The frame 10 can also be increased in size by, for example, telescoping, which can be applied to the extendable gate 16 in the embodiment of FIGS. 4A and 4B. When the length of the gate 16 is extended, the frame 10 can be correspondingly increased in length by telescoping.

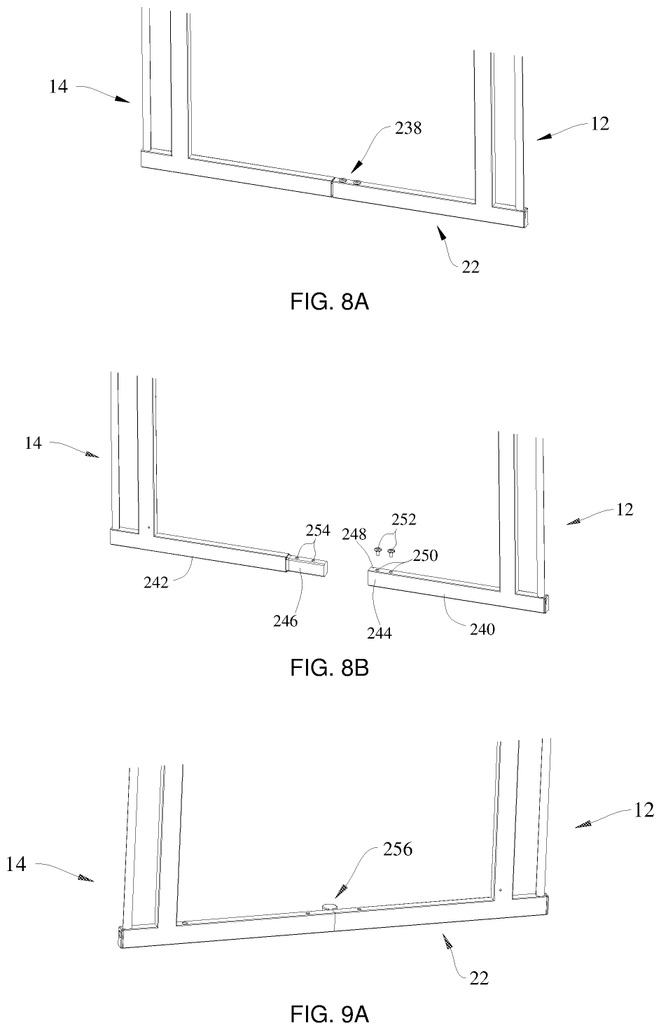

FIGS. 8A and 8B show a frame connection 238 of the phantom line 150 for the basic structure of FIGS. 1A and 1B. The frame connection 238 includes the lower member 22. The lower member 22 includes an end member portion 240 engaged to the first end frame 12 and an end member portion 242 engaged to the second end frame 14. Preferably, a length of each end member portion 240, 242 is substantially equal to or less than the length of the gate 16, so as to minimize the size of the carton for packaging or storing the barrier 100. The end member portions 240, 242 may be tubular. An inner end 244 of the end member portion 240 is integral with the end member portion 240 and has a same width and height, while an inner end 246 of the end member portion 242 are has a width and height that are slightly smaller than those of the end member portion 242, so that the inner end 246 can be received in the inner end 244 in a friction fit without forming a joint on the lower member 22, that is, the outer surfaces of the end member portions 240, 242 are substantially flat after engaging. A top wall 248 (which can also be a side wall) of the inner end 244 includes a pair of substantially horizontally aligned holes 250 for receiving a pair of pins 252, and the inner end 246 includes a pair of substantially horizontally aligned holes 254 which can be aligned with the holes 250 after the inner end 246 is slid into the inner end 244, and the pins 252 engage the inner ends 244 and 246. The pins 252 may be a screw or a rivet. It should be understood that the number of pins and holes is only illustrative.

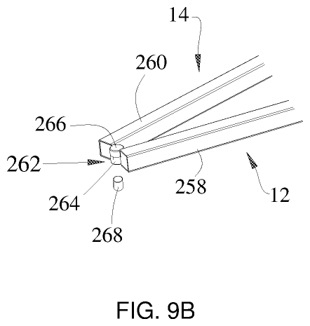

FIGS. 9A and 9B show a frame connection 256 of the phantom line 150 for the basic structure of FIGS. 1A and 1B. The frame connection 256 includes the lower member 22. The lower member 22 includes an end member portion 258 engaged to the first end frame 12, an end member portion 260 engaged to the second end frame 14, and an intermediate end member portion 262 engaged between the end member portions 258, 260. Preferably, a length of each end member portion 258, 260, 262 is substantially equal to or less than the length of the gate 16, so as to minimize the size of the carton for packaging or storing the barrier 100. The end member portions 258, 260 may be tubular. The intermediate end member portion 262 includes an articulated joint, which includes a first portion 264 engaged or integrated with the end member portion 258 and a second portion 266 engaged or integrated with the end member portion 260. The first portion 264 and the second portion 266 can rotate relative to each other, and engage with each other by a pin 268 to form the articulated joint that includes an axis that is generally parallel to the swinging axis of the gate 16. The intermediate end member portion 262 may include a locking mechanism (not shown in the drawings), which can be moved to a locked position to prevent the member portions 258, 260 from rotating relative to each other when the end member portions 258, 260 are substantially aligned with each other in a straight line, and the locking mechanism can be moved from the locked position to the unlocked position, so that the end member portions 258, 260 can be rotated to a folded position facing each other, so that the frame 10 can be packaged in a carton in a folded manner, which is convenient for transportation.

On the basis of FIG. 7A, 7B or 8A, 8B or 9A, 9B, it is also possible to extend the length of the frame 10 by providing an extension. The main part of the extension can refer to the embodiment of FIG. 7D. Besides, it is only necessary to construct the ends of the extension engaged to the end frames 12, 14 to be the same as the inner ends of the end member portion 214, 216, 240, 242, 258, 260 and then use the intermediate end member portions at the joints of the extensions and the frames 12, 14, so as to engage the extensions between the frames 12, 14, and it is also possible to use intermediate end member portions to engage two adjacent extensions, and each joint is provided with an intermediate end member portion.

When the gate connection shown in FIG. 2A, 2B, 3A, 3B, 3C, 3D, 3E, 3F, 3G, 3H, 3I, 3J, 3K, 3L, 3M, 3N, 3R, 3S, 4A, 4B, 5A, 5B, 6A, or 6B is used in combination with the frame connection shown in FIG. 4A, 7A, 7B, 7C, 7D, 8A, 8B, 9A, or 9B, the barrier 100 can have the following ways of reducing the package size: no splitting, two-pieces splitting, three-pieces splitting, four-pieces splitting, five-pieces splitting and six-pieces splitting. The non splitting means that both the gate 16 and the frame 10 can be folded or stretched to make the barrier 100 have a smaller overall size, and the gate 16 is engaged with the frame 10. The two-pieces splitting includes two cases. In one case, the two pieces of the split are the frame 10 and the gate 16, and then both the frame 10 and the gate 16 can be folded or stretched to make the barrier 100 have a smaller overall size. In another case, the two pieces of the split are the frame 10 engaged with the second gate frame 71 and the first gate frame 70, and the frame 10 can be folded or stretched to make the barrier 100 have a smaller overall size. The three-pieces splitting includes two cases. In one case, the three pieces of the split are the gate 16, the first end frame 12 and the second end frame 14, wherein the gate 16 can be folded or stretched to make the barrier 100 have a smaller overall size. In another case the three pieces of the split are the first end frame 12, the first gate frame 70, and the second end frame 14 engaged with the second gate frame 71. The four-pieces splitting is split into a first end frame 12, a second end frame 14, a first gate frame 70, and a second gate frame 71. The five-pieces splitting is split into the first gate frame 70, the second gate frame 71, the extension 270, the first end frame 12, and the second end frame 14, wherein the length of the first end frame 12 and the second end frame 14 can be adjusted by expansion and contraction. The six-pieces splitting is split into the first gate frame 70, the second gate frame 71, the extension 270, the first end frame 12, the second end frame 14 and the extension 290.

The above descriptions are only preferred embodiments and are not intended to limit the disclosure. Any modification, equivalent replacement and improvement made within the spirit and principle of the disclosure shall be included in the scope of protection

What is claimed is:

1. A barrier comprising: a frame and a gate engaged within the frame, the barrier having a first engaging state and a first disassembled state, a length of the frame in the first disassembled state being smaller than the length of the frame in the first engaging state, and a length of the gate in the first disassembled state is smaller than the length of the gate in the first engaging state.

2. The barrier of claim 1, wherein the first engaging state is a state in which the barrier can be used normally, and the first disassembled state is a state in which the barrier cannot be used normally.

3. The barrier of claim 1, wherein the frame includes a first end frame and a second end frame, and the gate includes a first gate frame and a second gate frame.

4. The barrier of claim 3, wherein in the first disassembled state, the first end frame, the second end frame, the first gate frame and the second gate frame remain engaged and the barrier is one-piece.

5. The barrier of claim 3, wherein in the first disassembled state, the first end frame and the second end frame remain engaged, the first gate frame and the second gate frame remain engaged, and the barrier is two-piece.

6. The barrier of claim 3, wherein in the first disassembled state, only the second end frame and the second gate frame remain engaged and the barrier is three-piece.

7. The barrier of claim 3, wherein in the first disassembled state, the first end frame, the second end frame, the first gate frame and the second gate frame are not engaged with each other, and the barrier is four-piece.

8. The barrier of claim 3, wherein in the first disassembled state, only the first gate frame and the second gate frame remain engaged, and the barrier is three-piece.

9. A barrier comprising: a frame and a gate engaged within the frame, the barrier having a first engaging state and a second engaging state, the first engaging state and the second engaging state are both states in which the barrier can be used normally, a length of the frame in the second engaging state being greater than a length of the frame in the first engaging state, and a length of the gate in the second engaging state is greater than a length of the gate in the first engaging state.

10. The barrier of claim 9, wherein the gate includes a first gate frame and a second gate frame, wherein, relative to the first engaging state, the gate further includes an extension engaged between the first gate frame and the second gate frame in the second engaging state.

11. The barrier of claim 9, wherein the gate includes a first gate frame and a second gate frame, the gate further including a first extension engaged between the first gate frame and the second gate frame in the first engaging state, the gate further including a second extension engaged between the first gate frame and the second gate frame in the second engaging state, wherein the second extension has a length that is greater than a length of the first extension.

12. The barrier of claim 9, wherein the gate includes a first gate frame, a second gate frame, and at least one extension engaged therebetween, and each of the extension has a substantially uniform length, wherein the number of the extensions in the second engaging state is more than the number of the extensions in the first engaging state.

13. The barrier of claim 9, wherein the frame includes a first end frame and a second end frame, wherein, relative to the first engaging state, the frame further includes an extension engaged between the first end frame and the second end frame in the second engaging state.

14. The barrier of claim 9, wherein the frame includes a first end frame and a second end frame, the frame further including a first extension engaged between the first end frame and the second end frame in the first engaging state, the frame further including a second extension engaged between the first end frame and the second end frame in the second engaging state, wherein the second extension has a length that is greater than a length of the first extension.

15. The barrier of claim 9, wherein the frame includes a first end frame, a second end frame, and at least one extension engaged therebetween, and each of the extensions has a substantially uniform length, wherein the number of the extensions in the second engaging state is more than the number of the extension in the first engaging state.

16. The barrier of claim 9, wherein the frame includes a first end frame and a second end frame, wherein the first end frame and the second end frame are configured to be telescopically engaged in a length direction, and can be changed between the first state and the second state by telescopic adjustment.

17. A barrier comprising:
a frame having first end frame and a second end frame;
a gate having a first gate frame and a second gate frame;
a first intermediate gate portion that joins the first gate frame to the second gate frame in a first engaging state; and
a second intermediate gate portion that joins the first gate frame to the second gate frame in a second engaging state,
wherein a length of the gate in the second engaging state is greater than a length of the gate in the first engaging state.

18. The barrier of claim 17, wherein the second intermediate gate portion is an extending portion that is longer than the first intermediate gate portion.

19. The barrier of claim 18, wherein the extending portion includes at least an upper member and a lower member and at least one tubular member between the upper member and the lower member.

20. The barrier of claim 17, further comprising a first frame intermediate portion that joins the first end frame and the second end frame in the first engaging state and a second frame intermediate portion that joins the first end frame and the second end frame in the second engaging state,
wherein a length of the frame in the second engaging state is greater than a length of the frame in the first engaging state.

21. The barrier of claim 20, wherein the second frame intermediate portion is an extending portion that is longer than the first frame intermediate portion.
